(19) United States
(12) Patent Application Publication
(10) Pub. No.: US 2013/0042044 A1
(43) Pub. Date: Feb. 14, 2013

(54) BRIDGE, SYSTEM AND THE METHOD FOR PRE-FETCHING AND DISCARDING DATA THEREOF

(71) Applicants: Yi-Hung Chen, Miaoli County (TW); Kung-Hsien Chu, Hsinchu City (TW)

(72) Inventors: Yi-Hung Chen, Miaoli County (TW); Kung-Hsien Chu, Hsinchu City (TW)

(73) Assignee: ITE TECH. INC., Hsinchu (TW)

(21) Appl. No.: 13/491,606

(22) Filed: Jun. 8, 2012

(30) Foreign Application Priority Data
Aug. 12, 2011 (TW) 100128943

(51) Int. Cl. G06F 13/36

(52) U.S. Cl. 710/310; 710/306

(57) ABSTRACT

A bridge system includes a request device, connected to a first bus; a target device, connected to a second bus; and a bridge, communicated with the first bus and the second bus, and the bridge has a buffer, wherein when the request device asks the bridge for reading data of a target address from the target device, a transaction is started, and the bridge asks the target device to transfer data of the target address and following addresses, and then the target device retrieves and transfers the data of the target address and following addresses to the bridge, that is stored in the buffer and then transferred to the request device in turn, and wherein as amount of transferred data to the request device reaches a threshold, the bridge continuously asks data of a following address of the target device before the transaction is finished.

### CROSS-REFERENCE TO RELATED APPLICATION

This application claims the priority benefit of Taiwan application serial no. 100128943, filed on Aug. 12, 2011. The entirety of the above-mentioned patent application is hereby incorporated by reference herein and made a part of this specification.

### BACKGROUND OF THE INVENTION

1. Field of the Invention

The invention relates to a bridge, bridge system and bridge method, and especially to a bridge, bridge system and bridge method for pre-fetching and discarding data.

2. Description of Related Art

A bridge is mainly to connect two interfaces for converting and/or transferring the signals between the two interfaces, such as Peripheral Component interconnect (PCI) and Peripheral Component interconnect Express (PCIe) interfaces, or Accelerated Graphics Port (AGP) and PCIe interfaces.

Please refer to FIG. 1 which depicts a conventional structure 1. A bridge 20 handles signal conversion and data transmission between a first bus 40 and a second bus 50. A request device 10 is connected to the first bus 40 and a target device 30 is connected to the second bus 50. Firstly, the request device 10 sends a reading signal to the bridge 20 for reading data from some address of the target device 30, which means a transaction starts. Secondly, the bridge 20 sends a reading signal to the target device 30. Thirdly, the target device 30 retrieves data of the address and the following addresses and transfers them to the bridge 20. Fourthly, the bridge 20 stores the data in a buffer 24 till predetermined amount. Finally, the bridge 20 transfers the data stored in the buffer 24 to the request device 10.

Generally, the bridge 20 will discard the data stored in the buffer when the transaction is finished. Or, when the request device 10 disconnects with the bridge 20, the transaction is deemed finished, and the bridge 20 will discard the data as well.

Meanwhile, if the request device 10 sends a reading signal to the bridge 20 for continuously reading data of following address from the target device 30, the bridge 20 will send a retry signal to the request device 10 because there is no data from the target device 30 stored in the buffer 24. After sending the retry signal, the bridge 20 sends a reading signal for reading data of the following address to the target device 30. Generally speaking, it will cost the target device 30 some time to retrieve the data of the following address and then transfers the data to the bridge 20. What's more, the bridge 20 will wait the data accumulating till the predetermined amount and then transfers them to the request device 10.

However, it happens that the bridge 20 disconnects with the request device 10 if the bridge 20 waits too long and the data are still not accumulated to the predetermined amount yet. At this time, the data stored in the buffer 24 will be discarded, and the request device 10 has no choice but to re-send a reading signal to the bridge 20.

The whole procedures stated above directly decrease the efficiency of the whole system. Therefore, IBM disclosed a method in U.S. Pat. No. 6,973,528 for solving the problem above. Please refer to FIG. 1 as well, the bridge 20 will pre-fetch additional data from the target device 30 and store them in the buffer 24 when the bridge 20 disconnects with the request device 10. Moreover, the amount the bridge 20 pre-fetched is more than the predetermined amount. As such, the bridge 20 will transfer data immediately when the request device 10 continues sending a reading signal for reading data of the following address from the target device 30 because the data are already stored in the buffer 24.

However, the method IBM disclosed does not reach the best efficiency of the whole system.

### SUMMARY OF THE INVENTION

The present invention discloses several embodiments which are able to enhance the efficiency of a bridge system.

In one aspect, a bridge system is disclosed. The bridge system includes a request device, connected to a first bus; a target device, connected to a second bus; and a bridge, communicated with the first bus and the second bus, and handling data transmission between the first bus and the second bus, the bridge has a buffer, wherein when the request device asks the bridge for reading data of a target address (i) from the target device, a transaction is started, and the bridge asks the target device to transfer data of the target address (i) and following zero-to-several addresses (i+0˜i+k), and then the target device retrieves the data of the target address (i) and following zero-to-several addresses (i+0˜i+k) and transfers the data of the target address (i) and following zero-to-several addresses (i+0˜i+k) to the bridge, and the data of the target address (i) and following zero-to-several addresses (i+0˜i+k) is stored in the buffer of the bridge, then transferred to the request device in turn, and wherein as amount of transferred data to the request device reaches a threshold, the bridge continuously asks data of a following address (i+k+1) of the target device before the transaction is finished.

In another aspect, a bridge method is disclosed. The bridge method includes the following steps: receiving a reading request from a request device for reading data from a target address of a target device, which means a transaction is started, wherein the request device is connected to a first bus, and the target device is connected to a second bus; asking the target device to transfer data of the target address (i) and following zero-to-several addresses (i+0˜i+k); transferring the data of the target address (i) and following zero-to-several addresses (i+0˜i+k) to the request device in turn; and continuously asking data of a following address (i+k+1) of the target device as amount of transferred data to the request device reaches a threshold before the transaction is finished.

In another aspect, a bridge method is also disclosed. The bridge method includes the following steps: receiving a reading request from a request device for reading data from a target address of a target device, which means a transaction is started, wherein the request device is connected to a first bus, and the target device is connected to a second bus; asking the target device to transfer data of the target address and following zero-to-several addresses; receiving the data of the target address and following zero-to-several addresses; storing the data of the target address and following zero-to-several addresses in a buffer; transferring the data of the target address and following zero-to-several addresses to the request device in turn; and continuously asking data of a following address of the target device to keep the buffer storing the data of the following address before the transaction is finished.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a structure of a conventional bridge.

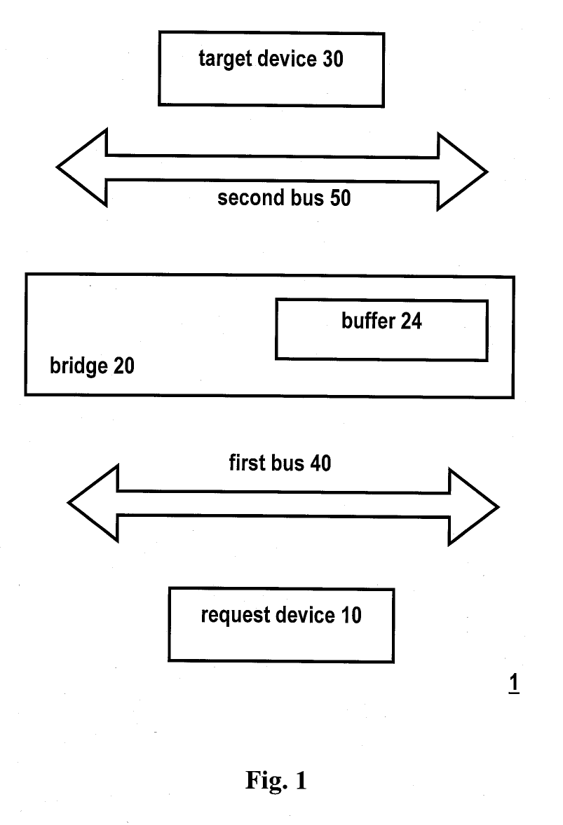

FIG. 2 is a bridge structure in accordance with a first embodiment of the present invention.

FIG. 3 is a bridge method in accordance with a second embodiment of the present invention.

FIG. 4 is a bridge method in accordance with a third embodiment of the present invention.

### DETAILED DESCRIPTION OF DISCLOSED EMBODIMENTS

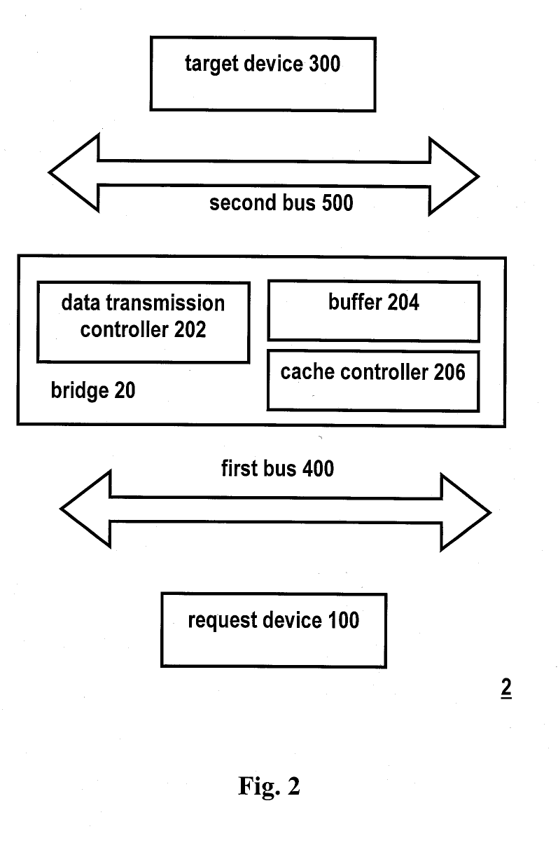

Please refer to FIG. 2 which depicted a bridge structure 2 in accordance with a first embodiment of the present invention. A bridge 200 handles signal conversion and data transmission between a first bus 400 and a second bus 500. A request device 100 is connected to the first bus 400 and a target device 300 is connected to the second bus 500. The bridge 200 includes a data transmission controller 202, a buffer 204 and a cache controller 206.

The first embodiment of the present invention will be illustratively explained with specific numbers for convenience. However, one skilled in the art understands that the numbers could be modified based on different design.

Firstly, a transaction starts, i.e. the request device 100 sends a reading signal to the bridge 200 for reading data of a target address of the target device 300. Assume that there are 64 KB data stored in one address, and the request device 100 desired to read 1024 KB data from target device 300. Secondly, the data transmission controller 202 of the bridge 200 sends a reading signal to the target device 300 for reading data of the target address and following addresses. Thirdly, the target device 300 retrieves data of the target address and following addresses and transfers them to the bridge 200. Fourthly, the bridge 200 stored the data in the buffer 204. The buffer 204 in accordance with the first embodiment is designed as being able to store 512 KB for each target device, such as the target device 300. Fifthly, the data transmission controller 202 of the bridge 200 starts to transfer the data stored in the buffer 204 to the request device 100 when the data of the target address and the following addresses from the target device 300 reach a predetermined amount, such as 192 KB in the first embodiment of the present invention.

In other words, after the target device 300 transfers 64 KB data of the target address (i), another 64 KB data of the following address (i+1), and another 64 KB data of the following address (i+2) to the bridge 200 to make the buffer 204 reach the predetermined amount, i.e. 192 KB, the data transmission controller 202 of the bridge 200 starts to transfer the 64 KB data of the target address (i) stored in the buffer 204 to the request device 100. The data transmission controller 202 sends a reading signal to the target device 300 for reading 64 KB data of the following address (i+3) as the data transmission controller 202 transferred the 64 KB data of the target address (i) to the request device 100. The procedure stated above repeats till the data transmission controller 202 transfers 64 KB data of the following address (i+m) to the request device 100 which reaches 1024 KB. Then, the request device 100 sends a transaction finished signal to the bridge 200.

In the first embodiment, before the transaction is finished, the bridge 200 presumes that the request device 100 would request data of following addresses if transferred data to the request device 100 reach a threshold, for example, 256 KB which depends on the system design. So, the cache controller 206 of the bridge 200 will continuously send a reading signal to the target device 300 for reading data of a following address. That is, before the transaction is finished, the bridge 200 pre-fetches the data of the following address and stored them in the buffer 204 because it presumes the request device 100 will request soon as the transferred data to the request device 100 reaches the threshold.

Or, the first embodiment could be implemented as the cache controller 206 of the bridge 200 will continuously send a reading signal to the target device 300 for reading data of a following address to keep the buffer 204 storing the data of the following address before the transaction is finished.

When the transaction is finished or the bridge 200 is disconnected, the cache controller 206 monitors the coming several requests from the request device 100 and sees whether there is any request for reading the data of the following address? If no, the cache controller 206 discards the data pre-fetched for the request device 100 and stored in the buffer 204.

Or, when the transaction is finished or the bridge 200 is disconnected, if the request device 100 sends a writing signal for writing the target device 300, the cache controller 206 discards the data pre-fetched for the request device 100 and stored in the buffer 204.

Or, when the transaction is finished or the bridge 200 is disconnected, if any device connected to the first bus 400 sends a reading/writing signal for reading/writing the request device 100 or any device connected to the second bus 500 sends a reading/writing signal to the bridge 200 for reading/writing the request device 100, the cache controller 206 discards the data pre-fetched for the request device 100 and stored in the buffer 204.

Or, when the transaction is finished or the bridge 200 is disconnected, if there is no space for buffer 204 to store any oncoming reading request and any device connected to the first bus 400 sends a reading signal to the bridge 200, the cache controller 206 discards the data pre-fetched for the request device 100 and stored in the buffer 204.

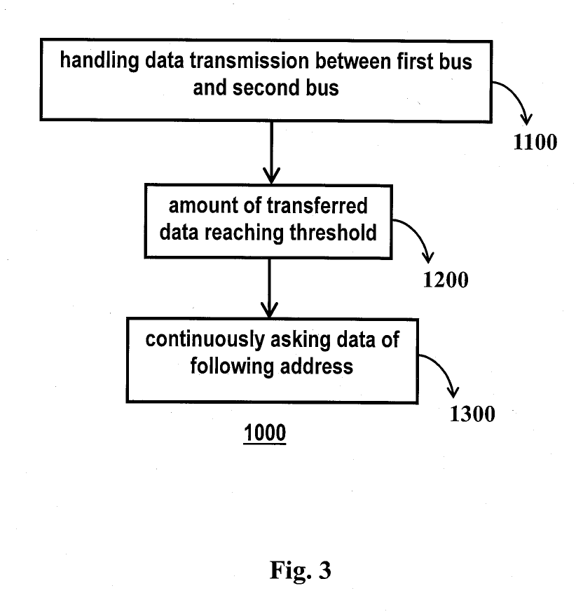

Next, please refer to FIG. 3 which depicted a bridge method 1000 in accordance with a second embodiment of the present invention. Firstly, a bridge handles data transmission between a first bus and a second bus (step 1100). For instance, a request device connected to the first bus is desired to read data of a target address from a target device connected to the second bus, and the bridge is used to control the data transmission of the target address and following addresses. Then, by the amount of data transferred till a threshold, such as 256 KB or 512 KB depended on the system design (step 1200), the bridge continuously asks data of a following address from the target device (step 1300).

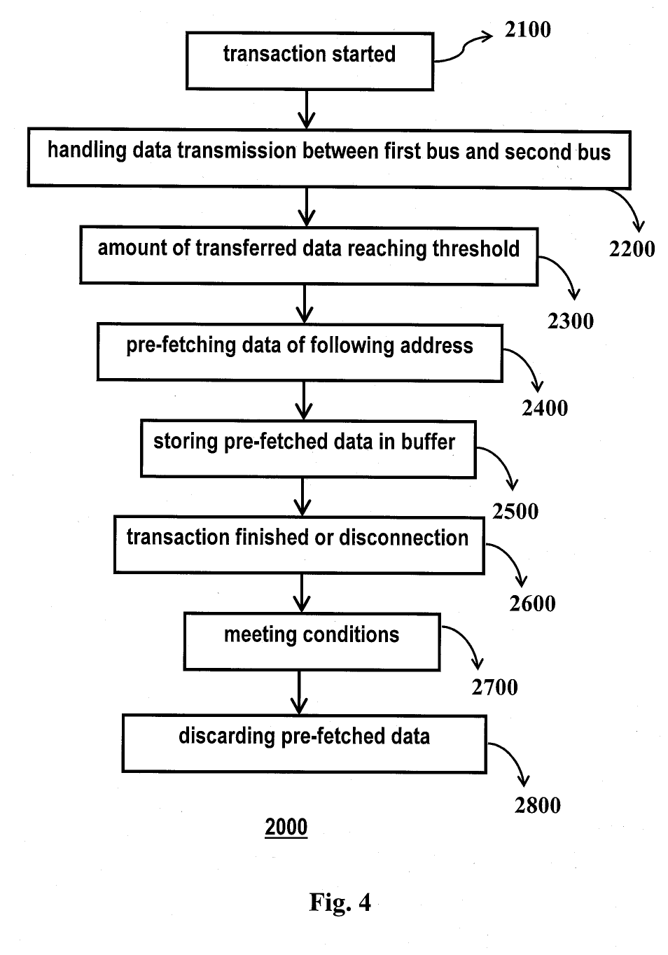

Next, please refer to FIG. 4 which depicted a bridge method 2000 in accordance with a third embodiment of the present invention. Firstly, a transaction starts (step 2100). For instance, a request device connected to the first bus is desired to read data of a target address from a target device connected to the second bus, and the bridge is used to control the data transmission of the target address and following addresses (step 2200). Then, by the amount of data transferred till a threshold, such as 256 KB or 512 KB depended on the system design (step 2300), the bridge continuously asks data of a following address from the target device (step 2400). That is, the bridge presumes that the request device would request data of following addresses, so it pre-fetch them in advance. Then, the bridge stores the pre-fetched data in a buffer (step 2500). When the transaction is finished or the bridge is disconnected (step 2600), if any predetermined condition is met (step 2700), the bridge discards the pre-fetched data (step 2800).

In the third embodiment, several conditions are set, which show the presumption above was wrong, so the bridge will discard the pre-fetched data in the buffer. The conditions are:

1. The coming several requests from the request device do not request for reading data of the following address which is followed a previous address when the transaction is finished or the bridge is disconnected. The monitoring number of the coming request may be set in a register of the bridge.

2. The request device asks to write data in the target device.

3. Any device connected to the first bus asks to read/write the request device or any device connected to the second bus asks the bridge to read/write the request device.

4. There is no space for buffer to store any oncoming reading request and any device connected to the first bus asks to read.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A bridge system, comprising:
a request device, connected to a first bus;
a target device, connected to a second bus; and
a bridge, communicated with the first bus and the second bus, and handling data transmission between the first bus and the second bus, the bridge has a buffer,
wherein when the request device asks the bridge for reading data of a target address (i) from the target device, a transaction is started, and the bridge asks the target device to transfer data of the target address (i) and following zero-to-several addresses (i+0˜i+k), and then the target device retrieves the data of the target address (i) and following zero-to-several addresses (i+0˜i+k) and transfers the data of the target address (i) and following zero-to-several addresses (i+0˜i+k) to the bridge, and the data of the target address (i) and following zero-to-several addresses (i+0˜i+k) is stored in the buffer of the bridge, then transferred to the request device in turn,
and wherein as amount of transferred data to the request device reaches a threshold, the bridge continuously asks data of a following address (i+k+1) of the target device before the transaction is finished.

2. The bridge system as recited in claim 1, wherein:
when the transaction is finished or the bridge is disconnected with the request device, and if the buffer stores data of a following address (i+p), the bridge monitors at least one request from the request device and sees whether any request ask to read the following address (i+p), and if no, the bridge discards the data of the following address (i+p).

3. The bridge system as recited in claim 1, wherein:
when the transaction is finished or the bridge is disconnected with the request device, and if the buffer stores data of a following address (i+p), and the request device ask to write the target device, the bridge discards the data of the following address (i+p).

4. The bridge system as recited in claim 1, wherein:
when the transaction is finished or the bridge is disconnected with the request device, and if the buffer stores data of a following address (i+p), and any device connected to the first bus asks to read/write the request device, or any device connected to the second bus asks the bridge to read/write the request device, the bridge discards the data of the following address (i+p).

5. The bridge system as recited in claim 1, wherein:
when the transaction is finished or the bridge is disconnected with the request device, and if the buffer stores data of a following address (i+p), and there is no space for the buffer to store any oncoming reading request, and any device connected to the first bus asks a reading request, the bridge discards the data of the following address (i+p).

6. A bridge, handling data transmission between a first bus and a second bus, comprising:
a data transmission controller, when a request device connected to the first bus asks the bridge to read data of a target address from a target device connected to the second bus, a transaction is started, the data transmission controller asks the target device to transfer data of the target address (i) and following zero-to-several addresses (i+0˜i+k);
a buffer, communicated with the data transmission controller, the data of the target address (i) and following zero-to-several addresses (i+0˜i+k) are transferred and stored in the buffer, and then, the data transmission controller transfers the data of the target address (i) and following zero-to-several addresses (i+0˜i+k) to the request device in turn; and
a cache controller, communicated with the data transmission controller, as amount of transferred data to the request device reaches a threshold, the bridge continuously asks data of a following address (i+k+1) of the target device before the transaction is finished.

7. The bridge as recited in claim 6, wherein:
when the transaction is finished or the bridge is disconnected with the request device, and if the buffer stores data of a following address (i+p), the bridge monitors at least one request from the request device and sees whether any request ask to read the following address (i+p), and if no, the bridge discards the data of the following address (i+p).

8. The bridge as recited in claim 6, wherein:
when the transaction is finished or the bridge is disconnected with the request device, and if the buffer stores data of a following address (i+p), and the request device ask to write the target device, the bridge discards the data of the following address (i+p).

9. The bridge as recited in claim 6, wherein:
when the transaction is finished or the bridge is disconnected with the request device, and if the buffer stores data of a following address (i+p), and any device connected to the first bus asks to read/write the request device, or any device connected to the second bus asks the bridge to read/write the request device, the bridge discards the data of the following address (i+p).

10. The bridge as recited in claim 6, wherein:
when the transaction is finished or the bridge is disconnected with the request device, and if the buffer stores data of a following address (i+p), and there is no space for the buffer to store any oncoming reading request, and any device connected to the first bus asks a reading request, the bridge discards the data of the following address (i+p).

11. A bridge method, comprising:
receiving a reading request from a request device for reading data from a target address of a target device, which means a transaction is started, wherein the request device is connected to a first bus, and the target device is connected to a second bus;
asking the target device to transfer data of the target address (i) and following zero-to-several addresses (i+0˜i+k);
transferring the data of the target address (i) and following zero-to-several addresses (i+0˜i+k) to the request device in turn; and
continuously asking data of a following address (i+k+1) of the target device as amount of transferred data to the request device reaches a threshold before the transaction is finished.

12. The bridge method as recited in claim 11, further comprising:
when the transaction is finished or the bridge is disconnected with the request device, and if the buffer stores data of a following address (i+p), monitoring at least one request from the request device and sees whether any request ask to read the following address (i+p); and
if no, discarding the data of the following address (i+p).

13. The bridge method as recited in claim 11, further comprising:
when the transaction is finished or the bridge is disconnected with the request device, and if the buffer stores data of a following address (i+p), and the request device ask to write the target device, discarding the data of the following address (i+p).

14. The bridge method as recited in claim 11, further comprising:
when the transaction is finished or the bridge is disconnected with the request device, and if the buffer stores data of a following address (i+p), and any device connected to the first bus asks to read/write the request device, or any device connected to the second bus asks the bridge to read/write the request device, discarding the data of the following address (i+p).

15. The bridge method as recited in claim 11, further comprising:
when the transaction is finished or the bridge is disconnected with the request device, and if the buffer stores data of a following address (i+p), and there is no space for the buffer to store any oncoming reading request, and any device connected to the first bus asks a reading request, discarding the data of the following address (i+p).

16. A bridge method, comprising:
receiving a reading request from a request device for reading data from a target address of a target device, which means a transaction is started, wherein the request device is connected to a first bus, and the target device is connected to a second bus;
asking the target device to transfer data of the target address and following zero-to-several addresses;
receiving the data of the target address and following zero-to-several addresses;
storing the data of the target address and following zero-to-several addresses in a buffer;
transferring the data of the target address and following zero-to-several addresses to the request device in turn; and
continuously asking data of a following address of the target device to keep the buffer storing the data of the following address before the transaction is finished.

17. The bridge method as recited in claim 16, further comprising:
when the transaction is finished or the bridge is disconnected with the request device, and if the buffer stores data of a following address (i+p), monitoring at least one request from the request device and sees whether any request ask to read the following address (i+p); and
if no, discarding the data of the following address (i+p).

18. The bridge method as recited in claim 16, further comprising:
when the transaction is finished or the bridge is disconnected with the request device, and if the buffer stores data of a following address (i+p), and the request device ask to write the target device, discarding the data of the following address (i+p).

19. The bridge method as recited in claim 16, further comprising:
when the transaction is finished or the bridge is disconnected with the request device, and if the buffer stores data of a following address (i+p), and any device connected to the first bus asks to read/write the request device, or any device connected to the second bus asks the bridge to read/write the request device, discarding the data of the following address (i+p).

20. The bridge method as recited in claim 16, further comprising:
when the transaction is finished or the bridge is disconnected with the request device, and if the buffer stores data of a following address (i+p), and there is no space for the buffer to store any oncoming reading request, and any device connected to the first bus asks a reading request, discarding the data of the following address (i+p).

21. A bridge method, comprising:
receiving a reading request from a request device for reading data from a target address of a target device, which means a transaction is started, wherein the request device is connected to a first bus, and the target device is connected to a second bus;
asking the target device to transfer data of the target address and following zero-to-several addresses;
receiving the data of the target address and following zero-to-several addresses;
storing the data of the target address and following zero-to-several addresses in a buffer;
transferring the data of the target address and following zero-to-several addresses to the request device in turn; and
continuously pre-fetching data of a following address of the target device as amount of transferred data to the request device reaches a threshold before the transaction is finished.
